(19) United States
(12) Patent Application Publication
(10) Pub. No.: US 2009/0222165 A1
(43) Pub. Date: Sep. 3, 2009

(54) INDUSTRIAL TRUCK HAVING A DEVICE FOR THE WEAR REDUCTION OF WHEELS WITH CUSHION TIRES

(75) Inventors: Jens Krause, Puteaux (FR); Dirk Passmann, Oberhausen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/371,725

(22) Filed: Feb. 16, 2009

(30) Foreign Application Priority Data
Feb. 15, 2008 (DE) 102008009193.6

(51) Int. Cl. G06F 7/00; B60C 23/19

(52) U.S. Cl. 701/36; 152/153

(57) ABSTRACT

An industrial truck comprises a plurality of wheels, each wheel comprising a hub and a cushion tire mounted thereon. The truck further comprises a sensor adapted to measure a temperature of a tread of one of the cushion tires and a control unit communicably coupled with the sensor and with at least one of a drive unit of the truck and a cooling unit associated with the tread.

### BACKGROUND OF THE INVENTION

1. Priority

Priority is claimed under 35 U.S.C. § 119 to German Patent Application No. 10 2008 009 193.6, filed Feb. 15, 2008. The disclosure of this priority application is incorporated herein by reference in its entirety.

2. Field of the Invention

The field of the present invention relates to industrial trucks, particularly industrial trucks that include a device for the wear reduction of the tread parts of the wheels, and to a corresponding process for wear reduction.

3. Background

Processes for monitoring pneumatic tires are sufficiently known in the prior art. In the majority of cases, a sensor is either applied inside the tire or directly incorporated by vulcanization into the tread of the tire when the tire is prepared. The transmission of corresponding data provided by the sensor about the pressure or the temperature of the tire to a receiver device is effected inductively. The receiver device is attached in close proximity to the tire. A typical example of such a device is found, for example, in DE 199 24 830 A1.

JP 07290916 A also describes a device for monitoring pneumatic tires of a vehicle, wherein an infrared sensor measures the surface temperature of the tire, which is regulated if necessary by a gas stream. Depending on the ratio of (purified) warm exhaust gas stream to the cold gas stream, the overall gas stream can have different temperatures.

DE 37 41 818 C1 describes a device for monitoring vehicle tires, especially pneumatic tires, during the drive comprising at least one measuring sensor for each wheel to be monitored, characterized in that sound sensors or temperature sensors detect the change of corresponding values measured on the tire/wheel, as known per se, by comparison in time or comparison among such measured values and transmit such change to an evaluation processor, which activates an indicator unit or sends control pulses to actuators when certain limits of admissible deviations of such measured values are exceeded; that microphones and/or structure-borne sound sensors as sound sensors and/or the temperature sensors are provided in the hub or on the frame of the vehicle in immediate proximity of each wheel; that said sound sensors and/or temperature sensors are connected to an electric or optical interface, which is in turn connected to a spectral analyzer, which is in turn connected to an evaluation processor via data lines (bus).

The mentioned actuators may cause, for example, a tire solution to be injected into the interior of the tire when there is a tire defect.

However, corresponding devices for monitoring the wheels of industrial trucks are not known in the prior art. In the vast majority of cases, these are not vehicles with pneumatic tires, but vehicles with tires having so-called cushion tires.

This means, for example, embodiments as described in DE 299 16 796 U1. They essentially consist of a hub part, a tread part and a cushion tire provided between these two parts, to which the actual damping properties can be attributed. Embodiments having a construction other than the just described three-part one are also possible. Namely, for suitable cushion tires, an additional separate tread part is not necessary. Thus, such embodiments are “only” two-part (=hub and cushion tire). In both embodiments, the cushion tire may be fixed on the hub by an adhesion promoter.

The term “tread of the wheels” (or briefly “tread”) is used herein to designate the surface of the tread part or of the cushion tire, which is in contact with the ground during the travel of the industrial truck and is heated as a consequence of the generated frictional heat.

Such wheels are employed not only in industrial truck technology, but also in plant construction, shelf conveyor technology and passenger transport technology. The cushion tire consists of solid rubber, polyurethane or another elastomer. The tread parts, if any, need not necessarily consist of a simple tire with a substantially flat tread, but may also be characterized by lateral or medial bulges and/or indentations which facilitate the guiding of such wheels, for example, on laid rails.

The lack of monitoring devices for such wheels is particularly surprising since they are subjected to significant loads too. Due to the costs caused by the necessary replacement of one or more wheels (both material costs and (downtime) costs due to the standstill of the industrial truck), there is a particular interest in a reduced wear of material.

### SUMMARY OF THE INVENTION

The present invention is directed toward an industrial truck which includes wheel sensors and a process for reducing the wear of wheel treads of an industrial truck. An industrial truck includes wheels comprising a hub and at least one cushion tire. The industrial truck comprises a sensor for measuring the temperature of a tread and a control unit connected with the sensor and with at least one of a drive unit of the vehicle and cooling unit associated with the wheel.

In the process for reducing the wear of the treads of an industrial truck, a sensor is positioned to monitor a temperature state of the tread. The sensor transmits signals to a control unit, the signals indicating the temperature state of the tread, and the control unit initiates one or more measures for reducing the temperature of the treads in accordance with the signals.

Accordingly, an improved industrial truck with wheel sensors and a process for monitoring the wear of treads of an industrial truck are disclosed. Advantages of the improvements will appear from the drawings and the description of the preferred embodiment.

### DETAILED DESCRIPTION OF THE PREFERRED EMBODIMENTS

Industrial trucks are a means of transportation that are mostly employed on the premises of a plant at ground level. They are examples of non-continuous conveyors. Today, the relevant standards also often use the terms “floorbound truck” or “ground conveyor”.

Industrial trucks include, for example: a) rail-borne industrial trucks, such as motive power units, carts, specialty vehicles and cranes, b) trackless industrial trucks, such as hand-operated trucks, staple trucks and powered trucks, and c) driverless transport vehicles.

The wheels of industrial trucks typically do not contain any hollow spaces containing air or another fluid. This is the case because wheels with hollow spaces are generally less suitable or not suitable at all for industrial trucks. As such, the present invention is directed toward industrial trucks that use cushion tires.

For the wheels, the above described three-part construction of cushion tires, consisting of a hub, cushion tire and tread part, is preferred. The two-part construction of cushion tires, as described above, is particularly preferred since the tread part can be omitted and the wheels are thus less expensive as a whole. Also, the production of wheels of the two-part type is less complicated than the production of wheels of the three-part type.

A “hub” is intended to mean a wheel element that serves to attach the wheel on the axle. A bearing and/or a coupling part (feather key, wedge, press fit, shrink disk or locking assembly) may be inserted therein. Also, it may be permanently connected with the related axle by a press tension.

A cushion tire, as is well known to those of skill in the art, is formed by an annular layer of an elastic material, such as rubber or another elastomer, provided on the hub. Preferably, the cushion tire is made of polyurethane.

The tires preferably have a hardness within a range of from 80 to 96 Shore A, especially within a range of from 92 to 94 Shore A. Within such ranges, the cushion tires have a high wear resistance while the elasticity is sufficient.

The tread part that covers the cushion tire, optionally on the whole circumferential surface thereof, is characterized, in particular, by its high hardness as compared to the underlying cushion tire. The high hardness ensures a high abrasion and temperature resistance and a resulting high wear resistance.

The tread parts need not necessarily consist only of a simple tire with a substantially flat tread, but may also be characterized by lateral or medial bulges and/or indentations which are supposed to facilitate the guiding of such wheels, for example, on laid rails.

In addition to the above described wheels whose wear is to be reduced, the industrial truck also comprises a device comprising at least one sensor for measuring the temperature of a tread, at least one control unit and at least one drive unit of the vehicle and/or a cooling unit for the wheel.

By mutual interactions of these device components and interactions thereof with the wheels of the industrial truck, as in the process described in more detail below, increases in temperature of the wheels, which is responsible for an excessive wear of the wheels, may be reduced to normal. Electrical connections may exist between the sensor, the control unit and/or the drive or cooling unit. However, the signal transmission may also be readily effected in an opto-electronic way, for example.

The sensor that measures the temperature may be a sensor inserted or incorporated into the tread part or the cushion tire (in a way similar to that already known in the prior art for pneumatic tires). However, since a thus incorporated sensor is a defect site, this embodiment is less preferred.

In contrast, the sensor is preferably a sensor suitable for contactless temperature measurement of the treads, because such a sensor need not be in direct contact with the wheel and/or need not be in immediate vicinity of the wheel, especially not in immediate vicinity of a cushion tire and/or a tread part. Preferably, it is an infrared sensor.

Such sensors attached at a distance from the wheel surface are preferably directed towards the treads of the wheels. This is advantageous because the temperature of the treads is to be considered the critical quantity that promotes wear.

infrared sensors can be attached at a significant distance from the wheel surface. This is very simply effected by attaching the infrared sensor at the side of the wheel housing facing the tread.

Such sensors attached at a distance from the wheel have found only limited application in the automobile industry in the monitoring of pneumatic tires because they are easily soiled and thus become non-functional when the motor vehicle is operated (for this reason, it is preferred to accommodate the sensor in the wheel for motor vehicles). This applies to a far lesser extent to industrial trucks, which are predominantly employed in roofed buildings, such as production halls or storage buildings.

The cooling unit, which is preferably attached to the industrial truck, is to serve the purpose of quickly and effectively cooling the tread or treads. For this purpose, it is particularly favorable if the cooling unit is directed towards at least one tread for applying a fluid stream, especially of water and/or air. Preferably, the cooling unit is a water sprayer, an air blower and/or a fan.

Water as the cooling agent is inexpensive, very readily available and non-combustible and is further characterized by a very high enthalpy of evaporation, so that only relatively low amounts of the actual cooling medium are required. A water-sprayer provides for uniform and effective wetting of the surface of the tread parts. However, when cooled with water or water and air, there is a risk that the coefficient of friction between the tread and ground will decrease and the braking distance of the industrial truck could be significantly increased, which is a safety risk. In addition, fluids such as water have the disadvantage that, especially for freely and independently movable industrial trucks, an excess of the fluid could be disturbing since it could be found in areas where it could represent a risk in terms of safety in the working place, for example, due to pedestrian traffic. Further, water promotes the rusting of iron parts both in the vehicle and in the building in which the industrial truck is operated.

Therefore, it is preferred if the fluid stream to be applied is a gas, especially air. This is realized simply, for example, by attaching a blower or a fan in the vicinity of the wheel, especially in the vicinity of the related tread. The drive unit is preferably an electric motor, gasoline or diesel engine.

The exact design of the control unit essentially depends on the nature of the sensor and the receiver of the signals from the control unit, i.e., the drive unit or the cooling unit. Usually, it is a microprocessor which compares the signals received with a (freely selectable) threshold value and sends signals to the receiver if the threshold value is exceeded, whereupon the receiver causes the cooling unit to activate, thereby reducing the temperature of the treads.

Preferably, when interacting with the drive unit, the control unit has such a design as to be capable not only to process the signals received from the sensor for temperature measurement, but additionally to receive and process signals from the drive unit. In this case, the speed of traveling of the vehicle, in other words, the angular velocity of at least one wheel, is reduced if it is above the maximum value for this speed as stored in the control unit.

Alternatively or additionally to the reduction of the angular velocity of one or more wheels, a temperature reduction may also be effected by the application of an external fluid stream directed towards at least one tread of at least one wheel. In this connection) the term “external” is to be understood as excluding the cooling effects brought about by the headwind.

Thus, an industrial truck with wheel sensors and a process for monitoring the wear of treads of an industrial truck are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. An industrial truck comprising
a plurality of wheels, each wheel comprising a hub and a cushion tire mounted thereon;
a sensor adapted to measure a temperature of a tread of one of the cushion tires; and
a control unit communicably coupled with the sensor and with at least one of a drive unit of the truck and a cooling unit associated with the tread.

2. The industrial truck according to claim 1, wherein each wheel further comprises at least one tread part covering the cushion tire.

3. The industrial truck according to claim 1, wherein the sensor is adapted to measure the temperature of the tread without direct contact with the wheel.

4. The industrial truck according to claim 1, wherein at least one sensor is directed towards at least one tread.

5. The industrial truck according to claim 1, wherein the sensor comprises an infrared sensor.

6. The industrial truck according to claim 1, wherein the cooling unit is adapted to direct a fluid stream onto the tread.

7. The industrial truck according to claim 1, wherein the fluid stream comprises a stream of water.

8. The industrial truck according to claim 1, wherein the fluid stream comprises an air stream.

9. The industrial truck according to claim 6, wherein the cooling unit comprises one of a water sprayer, an air blower, or a fan.

10. A process for reducing the wear of the treads of an industrial truck, the truck having a plurality of wheels, each wheel comprising a hub and a cushion tire mounted thereon, the process comprising:
measuring a temperature of a tread of one of the cushion tires with a sensor;
transmitting signals from the sensor to a control unit, the control unit being communicable coupled with at least one of a drive unit of the vehicle and a cooling unit associated with the tread; and
initiating one or more measures, via the control unit, for reducing the temperature of the tread in response to the signals.

11. The process according to claim 8, wherein initiating one or more measures includes reducing the angular velocity of at least one wheel.

12. The process according to claim 8, wherein initiating one or more measures includes directing an external fluid stream toward the tread.
